(19) United States
(12) Patent Application Publication
(10) Pub. No.: US 2004/0038660 A1
(43) Pub. Date: Feb. 26, 2004

(54) RF front-end for dual-mode wireless LAN module

(76) Inventors: Ziming He, Irvine, CA (US); Nopakorn Hiranrat, Walnut, CA (US); Ping Peng, Irvine, CA (US); Hung Tieu, Alhambra, CA (US); Yin Qian, Hacienda Hts., CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/226,006

(22) Filed: Aug. 21, 2002

(51) Int. Cl. H04B 7/00

(52) U.S. Cl. 455/277.1; 455/272

(57) ABSTRACT

A dual-mode Wireless Local Area Network (WLAN) module installed in an electronic device (600) for wireless communication with other electronic devices includes an RF front-end unit (30), two dual-band antennas (40) coupled to the RF front-end unit, a dual-band radio frequency integrated circuit (RFIC) (20) coupled to the RF front-end unit, a dual-band base-band integrated circuit (BBIC) (10) coupled to the RFIC, and an interface unit coupled to both the BBIC and a computer (600). The RF front-end consists of transmitting and receiving paths. The RF front-end unit has antenna diversity control switching circuits (31, 33) for selecting an appropriate antenna and switching circuits (32, 34, 35, 36) for controlling ON/OFF states of transmitting/receiving paths of the RF front-end unit.

### CROSS-REFERENCE TO RELATED APPLICATION

This application relates to a co-pending U.S. patent application with an unknown serial number, entitled “RF FRONT-END OF DUAL-MODE WIRELESS LAN MODULE”, invented by the same inventors, filed on the same date, and assigned to the same assignee as the present invention.

### BACKGROUND OF THE INVENTION

1. Field of the Invention

The present invention relates to a radio frequency (RF) front-end design, and more particularly to an RF front-end employed in a dual-mode Wireless Local Area Network (WLAN) module.

2. Description of the Prior Art and the Related Art

Wireless Local Area Network (WLAN) technology continues to advance in performance achieving Ethernet-like data rates. It is becoming more and more commonly used to service a variety of voice and data applications in the 2.4 GHz Industrial, Scientific and Medical (ISM) band. A paper, entitled “Technology economics of standards based WLAN solutions and cost of ownership” by Juan Figueroa, Bill Garon, Bob Pearson and Al Petrick of Intersil Corporation, analyzes cost of WLANs and concludes that the wireless technology and communication protocol proposed by the IEEE 802.11 Working Group is today already competitive with well established and mature technologies such as Ethernet. Further advances in RF silicon processes and in packaging technology, the paper claims, will enable the market to reach price levels that will make wireless LANs ubiquitous, and therefore the technology of choice.

There are an increasing number of wireless networking products becoming available on the market today, including Bluetooth devices, products based on the IEEE802.11b standard, and also products based on proprietary standards, such as HomeRF. But they all suffer from associated problems that hold back widespread acceptance. The allocated spectrum around 2.4 GHz is narrow, and is shared not only by Bluetooth and other wireless networking devices, but also by microwave ovens and many other ISM devices. It really is a crowded frequency band.

More bandwidth can support more users reliably, which is important for the enterprise and office environment. IEEE 802.11b-based products have a bandwidth of 835 MHz (2.4 to 2.4835 GHz) and only offer a maximum data rate of 11 Mbps, which is not enough. The allocated bandwidth in both the US and Europe for 802.11a-based products have a discontinuous bandwidth of 300 MHz (5.15 to 5.35 GHz, 5.725 to 5.825 GHz), which is more than twice the space allocated at 2.4 GHz. In addition, the 802.11a offers a maximum data rate up to 54 Mbps. The area of the spectrum is free from interference and the resulting data rates now compare with these in wired systems. Therefore, IEEE 802.11a operating at 5 GHz has developed into a new general standard.

Furthermore, more users hope to employ a WLAN terminal product which can operate both at 2.4 GHz and 5 GHz, rather than employ two different sets of products which respectively operate in different modes, because the latter has poor compatibility and mobility. To meet the trend, several Integrated Circuit (IC) design or semiconductor companies have developed dual-mode combo chipsets to support both 802.11a and 802.11b operation. Those already developing dual solutions include Envara Inc., Atheros Communications Inc., Synad Technologies Inc., Intel Inc., and others.

The current problem is how to design a complete product module with a dual-mode chipset including interconnection among each chip, an interface to peripheral equipment, and a radio frequency (RF) front-end, wherein the RF Front-End design is the key and most difficult part in the whole module design. U.S. Pat. Nos. 6,351,502 B1, and 6,205,171 B1 disclose several conventional RF front-ends or antenna interface units in wireless systems. However, neither of the two designs can adapt to a dual-mode WLAN module.

Hence, an RF front-end for a dual-mode WLAN module is required to overcome the disadvantages disclosed above.

### BRIEF SUMMARY OF THE INVENTION

A main object of the present invention is to provide a radio frequency (RF) front-end for a dual-mode Wireless Local Area Network (WLAN) module.

Another object is to provide a dual-mode WLAN module compatible with both IEEE 802.11a and IEEE 802.11b standard WLAN.

A further object is to provide a 802.11a/b dual-mode WLAN module for a mobile electronic device, such as a laptop computer.

A dual-mode WLAN module according to the present invention is installed in an electronic device for wireless communication with other electronic devices. The dual-mode WLAN module includes two dual-band antennas, an RF front-end unit coupled to a dual-band radio frequency integrated circuit (RFIC) chip and the dual-band antenna, a base-band integrated circuit (BBIC) chip coupled to the RFIC chip and an interface unit that connecting to a computer.

The RF front-end unit has a signal transmitting path and a-signal receiving path. The signal receiving path includes an antenna diversity unit for selecting an appropriate dual-band antenna and a first transmitting/receiving switch unit. The signal transmitting path includes a second transmitting/receiving switch unit. When the signal receiving path is ON, the signal transmitting path is OFF, and when the signal receiving path is OFF, the signal transmitting path is ON.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a 802.11a/b dual-mode Wireless Local Area Network (WLAN) module according to the present invention.

FIG. 2 is a partial block diagram of an RF front-end of FIG. 1, particularly showing a switch portion of the RF front-end.

FIG. 3 is a schematic diagram of an implementation example of the switch portion of FIG. 2.

### DETAILED DESCRIPTION OF THE INVENTION

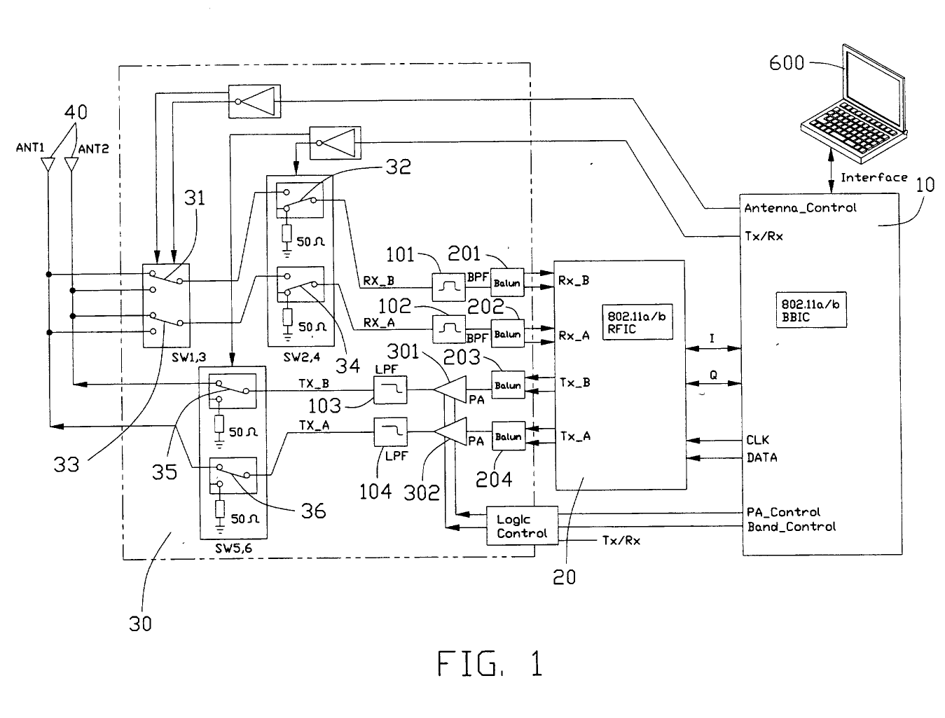

Referring to FIG. 1, a 802.11a/b dual-mode Wireless Local Area Network (WLAN) module according to the present invention comprises two main parts: a radio frequency (RF) part and a Base-Band part. The RF part includes two dual-band antennas 40, an RF front-end 30 and an RF integrated circuit (IC) 20. The Base-Band part includes a Base-Band (BB) IC 10 and an interface circuit (not labeled) to the RFIC 20. The Base-Band part further includes an interface (not shown) to electrically connect with a laptop computer 600.

The coupling between the RFIC 20 and the BBIC 10 can be conveniently achieved based on chipmakers' combined 802.11a/b chipset solution, and the coupling between the BBIC 10 and the interface is known to one skilled in the art, so detailed description about these couplings is omitted herein.

The dual-band antennas 40 covers 2.4 to 2.4835 GHz frequency band for IEEE802.11b standard communications and 5.15 to 5.825 GHz frequency band for IEEE802.11a standard communications. The RFIC 20 receives signals from and transmits signals to the dual-band antennas 40 via the RF front-end 30.

The RF front-end 30 includes a plurality of switches 31-36 for controlling the dual-band antennas' 40 diversity and Transmitter/Receiver functions, four filters 101-104, four baluns 201-204, and two power amplifiers 301, 302.

Signals received from the dual-band antennas 40 comprise a signal RX_B (2.4-2.4835 GHz) and a signal RX_A (5.15-5.825 GHz), which are selected by the switches 31-34. Then, the signal RX_B is filtered by the band pass filter (BPF) 101, and the filtered signal RX_B is transferred into the RFIC 20 via the balun 201. Similarly, the signal RX_A is filtered by the BPF 102, and the filtered signal RX_A is transferred into the RFIC 20 via the balun 202. Therefore, a signal receiving (RX) path is formed.

Signals sent to the dual-band antennas 40 for transmissions comprise a signal TX_B (2.4-2.4835 GHz) and a signal TX_A (5.15-5.825 GHz), which are generated by the RFIC 20. First, the signal TX_B is sent to the power amplifier 301 via the balun 203. Then, the signal TX_B which has been amplified by the power amplifier 301 is filtered by the low pass filter (LPF) 103, and the filtered signal TX_B is routed to the dual-band antennas 40 through the switch 35. Similarly, the signal TX_A is firstly sent to the power amplifier 302 via the balun 204. Then, the signal TX_A which has been amplified by the power amplifier 302 is filtered by the LPF 104, and the filtered signal TX_A is routed to the dual-band antennas 40 through the switch 36. Therefore, a signal transmitting (TX) path is formed.

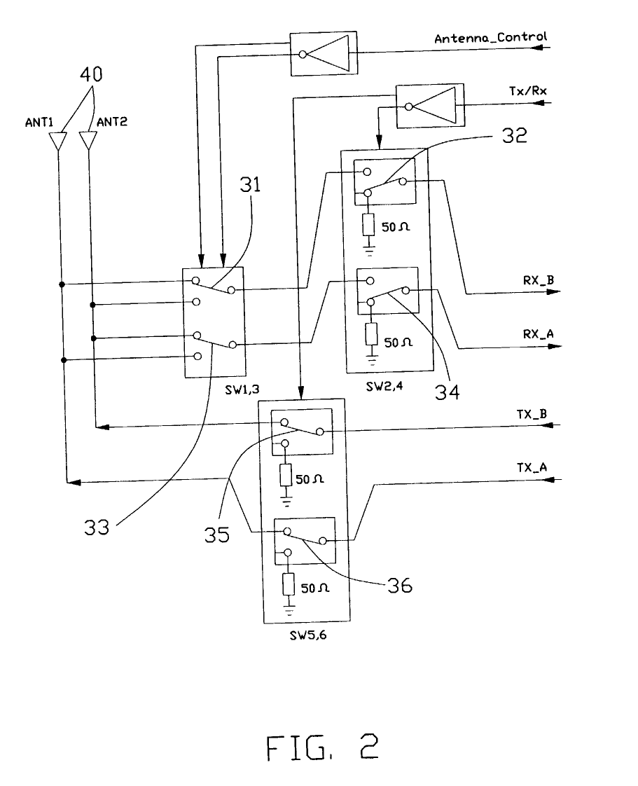

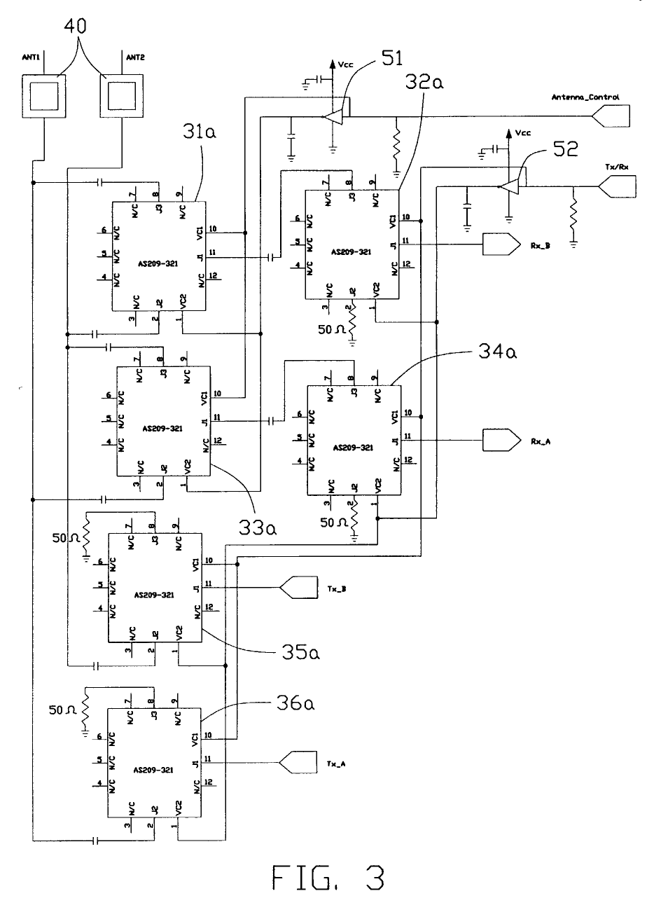

Referring to FIGS. 2 and 3, the switching functions of the switches 31-36 are respectively achieved by six similar Single Pole Double Throw (SPDT) switches 31a-36a. Antenna selection signal (Antenna_Control) generated by the BBIC 10 controls the switches 31a, 33a through an inverter 51. Transmitting/Receiving selection signal (Tx/Rx) generated by the BBIC 10 controls the flip-flops 32a, 34a, 35a, 36a through an inverter 52.

When the 802.11a/b dual-mode WLAN module transmits signals, under the control of the Tx/Rx signal, the switches 32, 34 are OFF and the switches 35, 36 are ON.

When the 802.11a/b dual-mode WLAN module receives signals, the switches 32, 34 are ON and the switches 35, 36 are OFF.

The 802.11a/b dual-mode WLAN module is mounted into the laptop computer 600 and the two dual-band antennas 40 are located in different locations in the laptop computer 600. Thus, the two dual-band antennas 40 have different receiving performances for incoming signals. When the incoming signal from one antenna is weak, the Antenna_Control signal controls the switches 31, 33 to select another antenna that has the better receiving performance.

Since the transmitting signal is much stronger than the receiving signal, the TX path has no antenna diversity switches, which results in less insertion loss.

By such a design, both the RX path and the TX path can work in 802.11a/b dual-mode. When the RX path is ON, the TX path is OFF, and vice versa, so good isolation between the RX path and the TX path can be achieved. In addition, there is no RF signal path crossover problem between the RX path and the TX path in this design so that layout of the printed circuit board design is easier.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna switch unit for controlling the transmitting/receiving of first and second frequency band signals, comprising:
a first and second dual-band antennas (40);
a first and a third switches (31, 33), each having capability to couple to the first and the second dual-band antennas;
a second and a fourth switches (32, 34) respectively coupled to the first and the third switches (31, 33); and
a fifth and a sixth switches (35, 36) respectively coupled to the first and the second dual-band antennas;
wherein the first dual-band antenna routes first frequency band transmitting signals via the fifth switch (35), the second dual-band antenna routes second frequency band transmitting signals via the sixth switch (36), first frequency band receiving signals are received sequentially through the first switch (31) and the second switch (32), and second frequency band receiving signals are received sequentially through the third switch (33) and the fourth switch (34).

2. The antenna switch unit as claimed in claim 1, wherein the first and third switches (31, 33) are controlled to mutually exclusively select either the first or the second antennas, whichever has the better receiving performance.

3. The antenna switch unit as claimed in claim 1, wherein when the second (32) and the fourth (34) switches are on, the fifth (35) and the sixth (36) switches are off, and when the second (32) and the fourth (34) switches are off, the fifth (35) and the sixth (36) switches are on.

4. The antenna switch unit as claimed in claim 1, wherein the control of each switch is achieved by a logic inverter.

5. A radio frequency (RF) front-end adapted to be employed in a dual-mode communication device to couple two dual-band antennas with an RF integrated circuit (RFIC), comprising:
a signal receiving path for receiving two different frequency band RF signals, comprising:
an antenna diversity unit (31 and 33) for selecting an appropriate dual-band antenna;
a first switch unit (32 and 34) coupled to the antenna diversity unit;
two band pass filters (BPFs) coupled to the first switch unit (32 and 34); and
two baluns respectively coupled to the two BPFs for transferring received RF signals to the RFIC; and
a signal transmitting path for transmitting the two different frequency band signals, comprising:
two baluns coupled to the RFIC to receive transmitting signals generated by the RFIC;
two power amplifiers respectively coupled to the two baluns;
two low pass filters (LPFs) respectively coupled to the two power amplifiers; and
a second switch unit (35 and 36) coupled to the two LPFs for routing the transmitting signals to the dual-band antennas.

6. The RF front-end as claimed in claim 5, wherein when the first switch unit (32 and 34) is on, the second switch unit (35 and 36) is off, and when the first switch unit is off, the second switch unit is on.

7. A dual-mode wireless communication module adapted to be installed in an electronic device to communicate with other electronic devices, comprising:
an interface unit adapted to electrically connect with the electronic device;
a Base-Band integrated circuit (BBIC) chip unit coupled to the interface unit;
a radio frequency integrated circuit (RFIC) chip unit coupled to the BBIC unit;
an RF front-end unit coupled to the RFIC unit; and
two dual-band antennas coupled to the RF front-end unit.

8. The dual-mode wireless communication module as claimed in claim 7, wherein the BBIC unit and the RFIC unit are capable of working in two different frequency bands.

9. The dual-mode wireless communication module as claimed in claim 7, wherein the RF front-end unit has a signal transmitting path and a signal receiving paths.

10. The dual-mode wireless communication module as claimed in claim 9, wherein the signal receiving path comprises an antenna diversity unit for selecting an appropriate dual-band antenna and a first transmitting/receiving switch unit (32 and 34), and the signal transmitting path comprises a second transmitting/receiving switch unit (35 and 36).

11. The dual-mode wireless communication module as claimed in claim 10, wherein when the signal receiving path is active (ON), the signal transmitting path is OFF, and when the signal receiving path is OFF, the signal transmitting path is ON.
